(19) United States
(12) Patent Application Publication
(10) Pub. No.: US 2024/0062929 A1
(43) Pub. Date: Feb. 22, 2024

(54) CABLE

(71) Applicant: SUMITOMO ELECTRIC INDUSTRIES, LTD., Osaka (JP)

(72) Inventors: Kenji HORI, Tochigi (JP); Takumi OOSHIMA, Tochigi (JP); Hirotaka KATO, Tochigi (JP); Shunya TASHIRO, Tochigi (JP); Wei FU, Tochigi (JP)

(21) Appl. No.: 18/363,108

(22) Filed: Aug. 1, 2023

(30) Foreign Application Priority Data
Aug. 17, 2022 (JP) 2022-130145

(51) Int. Cl. H01B 3/00; H01B 7/02

(52) U.S. Cl. CPC H01B 3/002; H01B 7/0216; H01B 3/30

(57) ABSTRACT

A cable includes a core including a plurality of electrical wires and a first resin layer configured to cover the core. The plurality of electrical wires is twisted together. The first resin layer includes a resin material and a filler. The content of the filler in the first resin layer is 10% by mass or more and 40% by mass or less. The filler is a chemical substance produced from a biological material.

### CROSS-REFERENCE TO RELATED APPLICATIONS

This application is based on and claims priority to Japanese Patent Application No. 2022-130145, filed on Aug. 17, 2022, the entire contents of which are incorporated herein by reference.

### TECHNICAL FIELD

The present disclosure relates to a cable.

### BACKGROUND

Japanese Laid-Open Patent Publication No. 2014-220043 describes an insulated electrical cable that includes a core member, a first covering layer, a second covering layer, and a tape member. The core member is formed by twisting together a plurality of core wires, each of which includes a conductor and an insulating layer that covers the core member. The first covering layer is formed so as to cover the core member. The second covering layer is formed so as to cover the first covering layer. The tape member is disposed between the core member and the first covering layer in a state in which the tape member is wrapped around the core member. The second covering layer is formed of a flame-retardant polyurethane-based resin, and the cross-sectional area of the conductor is in a range from 0.18 square millimeter (mm²) to 3.0 mm².

### SUMMARY

A cable according to the present disclosure includes a core including a plurality of electrical wires and a first resin layer configured to cover the core. The plurality of electrical wires is twisted together. The first resin layer includes a resin material and a filler. The content of the filler in the first resin layer is 10 percent (%) by mass or more and 40% by mass or less. The filler is a chemical substance produced from a biological material.

### BRIEF DESCRIPTION OF THE DRAWINGS

Other objects and further features of the present invention will be apparent from the following detailed description when read in conjunction with the accompanying drawings, in which:

FIG. 1 is a cross-sectional view of a cable in a plane perpendicular to the longitudinal direction of the cable according to an aspect of the present disclosure.

FIG. 2 is a drawing illustrating a twisted-pair electrical wire according to a modification; and

FIG. 3 is a cross-sectional view of a cable in a plane perpendicular to the longitudinal direction of the cable according to another aspect of the present disclosure.

### DETAILED DESCRIPTION

In recent years, there has been a marked increase in interest in environmental issues. For this reason, in order to decrease the environmental load, there is a need for a cable having a high biomass degree and a reduced content of a petroleum-derived resin material.

According to the present disclosure, a cable having a high biomass degree can be provided.

In the following, embodiments of the present disclosure will be described.

### DESCRIPTION OF EMBODIMENTS OF PRESENT DISCLOSURE

First, the embodiments of the present disclosure will be listed and described. In the following description, the same or corresponding components are denoted by the same reference numerals and the description thereof will not be repeated.

(1) A cable according to an aspect of the present disclosure includes a core including a plurality of electrical wires; and a first resin layer configured to cover the core. The plurality of electrical wires is twisted together. The first resin layer includes a resin material and a filler. The content of the filler in the first resin layer is 10% by mass or more and 40% by mass or less. The filler is a chemical substance produced from a biological material.

When the resin layer includes the filler, which is the chemical substance produced from the biological material, the content of a petroleum-derived resin material can be reduced more than before. The filler, which is the chemical substance produced from the biological material, is not a non-renewable resource. Therefore, when the resin layer includes the filler and the content of the resin material in the resin layer is reduced, the environmental load can be decreased.

Further, carbon dioxide generated when the filler, which is the chemical substance produced from the biological material, is incinerated is carbon dioxide absorbed and fixed during the growth process of organisms that are the raw materials of the filler. Accordingly, the carbon dioxide produced when the filler is incinerated does not increase carbon dioxide in the atmosphere.

Therefore, by causing the resin layer to include the filler so as to reduce the amount of the resin material used, even when the resin layer is incinerated at the time of disposal of the cable including the resin layer, an increase in the amount of carbon dioxide in the atmosphere can be suppressed. Accordingly, the cable according to the aspect of the present disclosure can decrease the environmental load.

It is conceivable that a biological material, such as rice, corn, shells, wood, or the like, can be used as the filler as it is. However, if a biological material is used as the filler as it is, it would be difficult to control the particle size. In addition, the strength and the insulation property of the resin layer would not be sufficiently enhanced. Further, the resin layer can be formed by extrusion or the like; however, if a biological material is used as the filler as it is, the filler would be clogged in a molding machine, and as a result, productivity would be reduced.

In view of the above, in the cable according to an aspect of the present disclosure, the chemical substance produced from the biological material can be used as the filler. By using the chemical substance produced from the biological material, the particle size of the filler can be easily controlled. Therefore, the productivity of the cable can be improved, and the biomass degree of the resin layer and the cable can be increased. In addition, the strength and the insulation property of the resin layer can be enhanced.

When the content of the filler in the resin layer is 10% by mass or more, the biomass degree of the resin layer and the cable can be increased, and the amount of the resin material used can be reduced, thereby decreasing the environmental load. When the content of the filler in the resin layer is 40% by mass or less, the strength and the insulation property of the resin layer can be enhanced.

(2) In the above (1), the cable may further include a second resin layer configured to cover the core.

When the cable according to an aspect of the present disclosure includes the second resin layer, the plurality of electrical wires can be protected, and the strength of the cable can be thus enhanced.

(3) In the above (2), the second resin layer may include a resin material that is same as the resin material of the first resin layer.

When the second resin layer includes the same resin material as the first resin layer, the adhesion between the first resin layer and the second resin layer can be improved, thus increasing durability.

(4) In any of the above (1) to (3), the filler may include starch.

Starch can be inexpensively produced from, for example, rice or corn. That is, starch can be inexpensively produced from a readily available biological material. Therefore, when the filler includes starch as the chemical substance produced from the biological material, the productivity of the cable can be improved while reducing the manufacturing cost of the cable. In addition, the biomass degree of the resin layer and the cable can be increased. Further, the strength and the insulation property of the resin layer can be enhanced.

(5) In any of the above (1) to (4), the filler may include calcium carbonate.

Calcium carbonate can be inexpensively produced from, for example, oyster shells or scallop shells. That is, calcium carbonate can be inexpensively produced from a readily available biological material. Therefore, when the filler includes calcium carbonate as the chemical substance produced from the biological material, the productivity of the cable can be improved while reducing the manufacturing cost of the cable. In addition, the biomass degree of the resin layer and the cable can be increased. Further, the strength and the insulation property of the resin layer can be enhanced.

(6) In any of the above (1) to (5), the filler may include cellulose.

Cellulose can be inexpensively produced from, for example, wood. That is, cellulose can be inexpensively produced from a readily available biological material. Therefore, when the filler includes calcium cellulose as the chemical substance produced from the biological material, the productivity of the cable can be improved while reducing the manufacturing cost of the cable. In addition, the biomass degree of the resin layer and the cable can be increased. Further, the strength and the insulation property of the cable can be enhanced.

(7) In any of the above (1) to (6), the resin material may be cross-linked.

When the resin material is cross-linked, the heat resistance and the strength of the cable can be enhanced.

(8) In any of the above (1) to (7), the cable may further include a separator between the core and the resin material.

When the cable according to an aspect of the present disclosure includes the separator, the resin layer can be readily removed when the plurality of electrical wires is taken out, and the workability when performing wiring and the like can be improved.

### DETAILS OF EMBODIMENTS OF PRESENT DISCLOSURE

Specific examples of a cable according to an embodiment (hereinafter referred to as the “present embodiment”) of the present disclosure will be described below with reference to the accompanying drawings. Note that the present invention is not limited to these examples, and is intended to include all changes and modifications within the scope of the appended claims and within the meaning and scope of the equivalents of the appended claims.

[Cable]

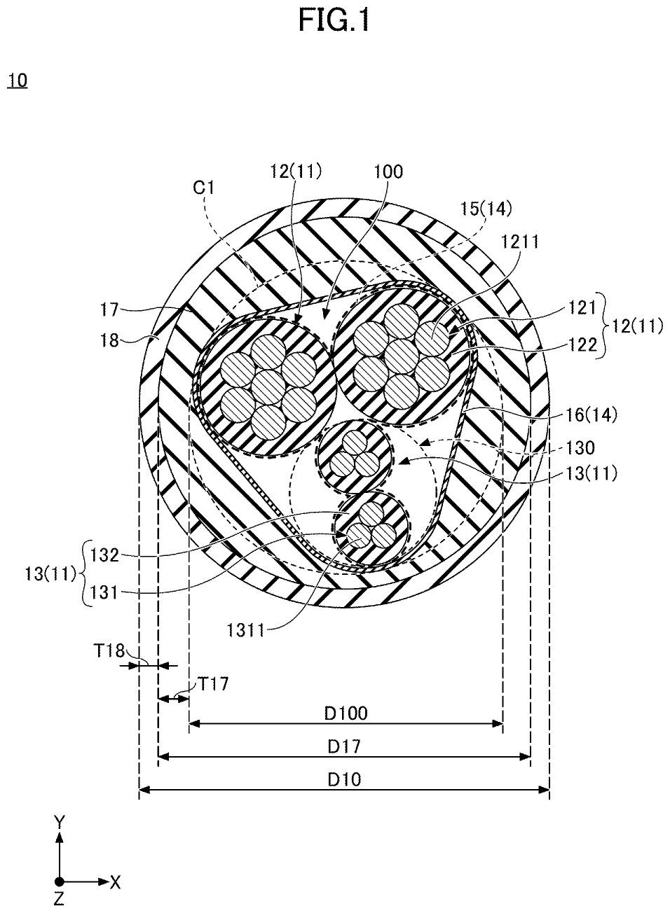

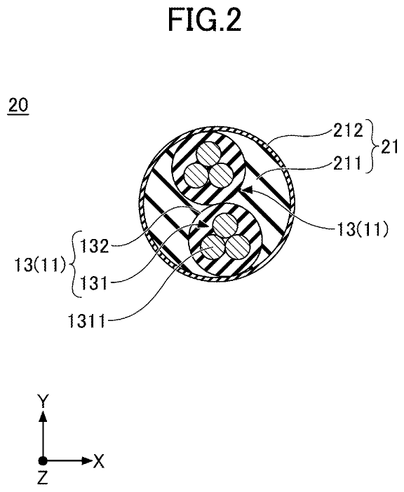

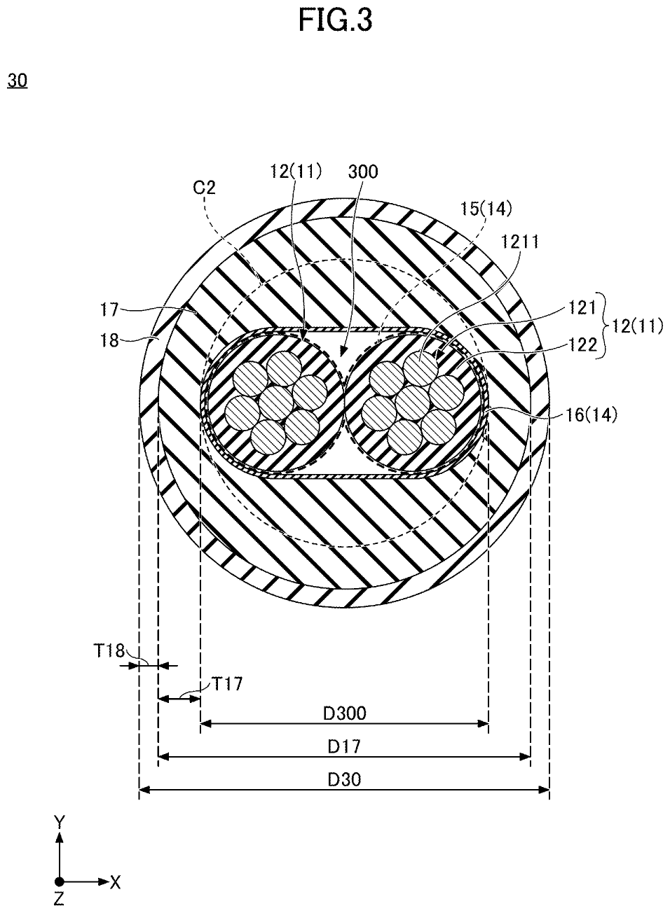

An example configuration of the cable according to the present embodiment will be described with reference to FIG. 1 through FIG. 3. In FIG. 1 and FIG. 3, cross sections perpendicular to the longitudinal direction of cables are depicted. In FIG. 2, a cross section perpendicular to the longitudinal direction of a twisted-pair electrical wire is depicted.

In FIG. 1 through FIG. 3, a Z-axis direction, that is, a direction perpendicular to a paper surface corresponds to the longitudinal direction of the cables or the electrical wire, and an XY plane corresponds to a plane perpendicular to the longitudinal direction of the cables or the like.

FIG. 2 illustrates a twisted-pair electrical wire according to a modification, which can be included in the cable according to the present embodiment. FIG. 3 illustrates a cable according to a modification. Therefore, for description, FIG. 1 is mainly used, and FIG. 2 and FIG. 3 are used as necessary.

As illustrated in FIG. 1, a cable 10 according to the present embodiment includes a core including a plurality of electrical wires 11; and a resin layer 17 configured to cover the core 100. The plurality of electrical wires 11 is twisted together.

In the following, members of the cable according to the present embodiment will be described.

(1) Electrical Wires

(1-1) Configuration Example of Electrical Wires

The electrical wires 11 are covered electrical wires that perform functions required for power supply, voltage application, communication, devices, and the like.

Each of the electrical wires 11 can include conductors and an insulator that covers the conductors.

As illustrated in FIG. 1, the plurality of electrical wires 11 of the cable 10 can include first electrical wires 12 and second electrical wires 13.

Each of the first electrical wires 12 includes conductors 121 and an insulator 122 that covers the outer peripheries of the conductors 121.

Each of the second electrical wires 13 includes conductors 131 and an insulator 132 that covers the conductors 131.

The configurations of members of the first electrical wires 12 and the second electrical wires can be selected according to the application and the like. For example, as illustrated in FIG. 1, the first electrical wires 12 can have a larger conductor cross-sectional area than that of the second electrical wires 13.

In this case, the first electrical wires can be, for example, power supply wires. For example, the first electrical wires 12 can be used to connect an electric parking brake (EPB) and an electric control unit (ECU).

The second electrical wires 13 can be, for example, signal wires. For example, the second electrical wires 13 can be used for anti-lock brake system (ABS) wiring.

An example in which the cable according to the present embodiment is used for automotive wiring will be explained; however, the use of the cable is not limited thereto. The cable according to the present embodiment can be used for wiring between various devices or wiring inside a device. For example, the cable according to the present embodiment can also be used for factory automation wiring.

FIG. 1 illustrates an example in which the two first electrical wires 12 and the two second electrical wires 13, of the plurality of electrical wires 11 of the cable 10, are of different types. However, the present invention is not limited to this configuration. The configuration of the electrical wires 11 of the cable according to the present embodiment can be selected according to devices or the like to which the electrical wires 11 are to be connected.

The cable according to the present embodiment can include three or more types of electrical wires in which one or more of conductor materials, conductor configurations such as conductor cross-sectional areas, insulator materials, and insulator configurations such as the thicknesses of insulators differ. Further, in the cable 10 illustrated in FIG. 1, the number of the first electrical wires 12 and the number of the second electrical wires 13 may be changed to one or three or more.

The cable according to the present embodiment can include one type of electrical wire having the same configuration, as in the case of a cable 30 illustrated in FIG. 3. The cable 30 illustrated in FIG. 3 includes two first electrical wires 12; however, the configuration of the cable 30 is not limited thereto. The cable according to the present embodiment can be configured to include two second electrical wires 13 having a smaller conductor cross-sectional area than that of the cable 30 illustrated in FIG. 3. Further, the cable according to the present embodiment can be configured to include three or more electrical wires having the same configuration.

Members of electrical wires will be described.

(Conductors)

In the example illustrated in FIG. 1, each of the conductors 121 of the first electrical wires 12 is a stranded wire having a plurality of conductor wires 1211 twisted together. In addition, each of the conductors 131 of the second electrical wires 13 is a stranded wire having a plurality of conductor wires 1311 twisted together. However, the configurations of the conductors included in the electrical wires 11 are not limited thereto. Each of the conductors may be a single wire. Therefore, each of the conductors may be composed of a single conductor wire or may be composed of a plurality of conductor wires.

The material of the conductors is not particularly limited. For example, one or more conductor materials selected from, for example, a copper alloy, copper, silver plated soft copper, and tin plated soft copper can be used. As copper, soft copper can be suitably used.

If each of the conductors is a stranded wire having a plurality of conductor wires, the wire diameter and the number of the conductor wires are not particularly limited. According to the application or the like of the electrical wires 11, the wire diameter and the number of the conductor wires can be selected so as to obtain a desired conductor cross-sectional area.

The conductor cross-sectional area of each of the electrical wires 11 is not particularly limited. For example, each of the conductors included in the electrical wires 11 preferably has a conductor cross-sectional area of 0.13 mm 2 or more and 3.5 mm 2 or less.

(Insulator)

The material of an insulator is not particularly limited. For example, one or more resin materials selected from a polyolefin-based resin such as polyethylene and polypropylene, a polyvinyl chloride resin (PVC), a thermoplastic elastomer (TPE), and the like can be used. The resin material of the insulator may or may not be cross-linked.

In addition to the above-described resin material, the insulator can also include an additive such as a flame retardant, a flame retardant aid, an antioxidant, a lubricant, a colorant, a reflective additive, a concealer, a processing stabilizer, or a plasticizer.

The members constituting the first electrical wires 12 and the second electrical wires may be formed of the same material or may be formed of different materials.

(1-2) Twisted-Pair Electrical Wire

The cable according to the present embodiment can include a twisted-pair electrical wire having two electrical wires twisted together. In this case, the twisted-pair electrical wire and any other electrical wire(s) can be twisted to form a core.

Specifically, as in the case of the cable illustrated in FIG. 1, the two second electrical wires 13 can be twisted together spirally along the longitudinal direction of the cable 10 to form a twisted-pair electrical wire 130. The core 100 of the cable 10 illustrated in FIG. 1 has a configuration in which the two first electrical wires 12 and the twisted-pair electrical wire 130, which is obtained by twisting the two second electrical wires 13 together in advance, are twisted together.

As described, by twisting two electrical wires of the same type to form a twisted-pair electrical wire, signals transmitted by the electrical wires can be less susceptible to noise.

Further, three or more electrical wires can be twisted together to form an assembled electrical wire.

(Covering Layer)

As in the case of a twisted-pair electrical wire 20 illustrated in FIG. 2, a covering layer 21 can be further included. The covering layer 21 covers two second electrical wires 13 that are twisted together. The covering layer 21 may be composed of one layer, or may be composed of a first covering layer 211 and a second covering layer 212. As illustrated in FIG. 2, the first covering layer can be disposed to cover the outer peripheries of the two second electrical wires 13. The second covering layer 212 can be disposed to cover the outer surface of the first covering layer 211.

The material of the covering layer 21 is not particularly limited. As the material of the first covering layer 211, one or more selected from a thermoplastic polyurethane elastomer, an ethylene-vinyl acetate copolymer (EVA), and an ethylene-ethyl acrylate copolymer (EEA) can be suitably used, for example. As the material of the second covering layer 212, a thermoplastic polyurethane elastomer or the like can be suitably used, for example.

The covering layer 21 may be formed by winding a tape, or may be a resin tube formed by extrusion.

(1-3) Core

A plurality of electrical wires included in the cable according to the present embodiment can be twisted together to form a core.

In the cable 10 illustrated in FIG. 1, the two first electrical wires 12 and the twisted-pair electrical wire 130, obtained by twisting the two second electrical wires 13 together in advance, are twisted together to form the core 100, as described above. In the case of the cable 30 illustrated in FIG. 3, the two first electrical wires 12 are twisted together to form a core 300.

The number of electrical wires 11 included in the cable according to the present embodiment is not particularly limited. For example, the number of electrical wires 11 may be two or more and ten or less.

(2) Resin Layer

As illustrated in FIG. 1, the resin layer 17 can cover the outer surfaces of the plurality of electrical wires 11, specifically the outer surfaces along the longitudinal direction of the plurality of electrical wires 11.

The resin layer 17 can cover the core 100. The resin layer 17 covering the core 100 means that the core 100 is disposed within the resin layer 17, and the resin layer 17 and the core 100 do not necessarily contact each other.

The resin layer 17 can include a resin material and a filler, which will be described below.

(2-1) Resin Material

The resin layer 17 can include a resin material. The resin material is not particularly limited. For example, as the resin material, one or more selected from a polyolefin-based resin, a polyurethane (PU) resin, and a polyvinyl chloride (PVC) resin can be preferably used.

The resin material may be a biomass-derived resin material, a biomass-derived polyolefin-based resin, or the like. By using the biomass-derived resin material as the resin material, the amount of a petroleum-derived resin material used can be reduced, and the biomass degree of the resin layer and the cable can be increased.

In the present specification, the biomass degree means the mass percentage of a contained biomass material.

The polyolefin-based resin is not particularly limited. Examples of the polyolefin-based resin include polyethylene (PE), ethylene acrylate copolymers, such as ethylene-vinyl acetate copolymers (EVA) and ethylene-ethyl acrylate copolymers (EEA), ethylene α-olefin copolymers, ethylene methyl acrylate copolymers, ethylene butyl acrylate copolymers, ethylene methyl methacrylate copolymers, ethylene acrylic acid copolymers, partially saponified EVAs, maleic anhydride modified polyolefins, and ethylene acrylate maleic anhydride copolymers. One of these resins may be used alone, or two or more of these resins may be used in combination.

The resin material may or may not be cross-linked.

If the resin material is cross-linked, the heat resistance and the strength of the cable 10 can be enhanced. Therefore, if the cable 10 is used for applications requiring heat resistance and strength, the resin material is preferably cross-linked.

(2-2) Filler

The resin layer 17 can include a filler. The filler may be a chemical substance produced from a biological material corresponding to a biomass material.

When the resin layer 17 includes the filler, which is the chemical substance produced from the biological material, the content of a petroleum-derived resin material can be reduced more than before. The filler, which is the chemical substance produced from the biological material, is not a non-renewable resource. Therefore, when the resin layer 17 includes the filler and the content of the resin material in the resin layer 17 is reduced, the environmental load can be decreased.

Further, carbon dioxide generated when the filler, which is the chemical substance produced from the biological material, is incinerated is carbon dioxide absorbed and fixed during the growth process of organisms that are the raw materials of the filler. Accordingly, the carbon dioxide produced when the filler is incinerated does not increase carbon dioxide in the atmosphere.

Therefore, by causing the resin layer 17 to include the filler so as to reduce the amount of the resin material used, even when the resin layer is incinerated at the time of disposal of the cable including the resin layer, an increase in the amount of carbon dioxide in the atmosphere can be suppressed. Accordingly, the cable according to the present embodiment can decrease the environmental load.

It is conceivable that a biological material, such as rice, corn, shells, wood, or the like, can be used as the filler as it is. However, if a biological material is used as the filler as it is, it would be difficult to control the particle size. In addition, the strength and the insulation property of the resin layer 17 would not be sufficiently enhanced. Further, the resin layer 17 can be formed by extrusion or the like; however, if a biological material is used as the filler as it is, the filler would be clogged in a molding machine, and as a result, productivity would be reduced.

In view of the above, in the cable according to the present embodiment, the chemical substance produced from the biological material can be used as the filler. By using the chemical substance produced from the biological material, the particle size of the filler can be easily controlled. Therefore, the productivity of the cable can be improved, and the biomass degree of the resin layer 17 and the cable can be increased. In addition, the strength and the insulation property of the resin layer 17 can be enhanced. The strength of the resin layer 17 means that no appearance abnormality such as breaking or cracking is observed when the cable is repeatedly bent.

The chemical substance produced from the biological material (hereinafter also simply referred to as the “chemical substance”) is not particularly limited. The filler can include, for example, starch as the chemical substance. The filler can include, for example, calcium carbonate as the chemical substance. The filler can include, for example, cellulose as the chemical substance.

The filler can include a plurality of different chemical substances. For example, the filler can include one or more selected from starch, calcium carbonate, cellulose, and the like.

Starch can be inexpensively produced from, for example, rice or corn. Calcium carbonate can be inexpensively produced from, for example, shells of oysters, scallops, or the like. Cellulose can be inexpensively produced from, for example, wood. That is, starch, calcium carbonate, and cellulose can be inexpensively produced from readily available biological materials. Therefore, when the filler includes one or more selected from starch, calcium carbonate, and cellulose as chemical substances, the productivity of the cable can be improved while reducing the manufacturing cost of the cable. In addition, the biomass degree of the resin layer 17 and the cable 10 can be increased. Further, the strength and the insulation property of the resin layer 17 can be enhanced.

The content of the filler in the resin layer 17 of the cable 10 according to the present embodiment can be 10% by mass or more and 40% by mass or less. When the content of the filler in the resin layer 17 is 10% by mass or more, the biomass degree of the resin layer 17 and the cable 10 can be increased, and the amount of the resin material used can be reduced, thereby decreasing the environmental load. When the content of the filler in the resin layer 17 is 40% by mass or less, the strength and the insulation property of the resin layer 17 can be enhanced.

(2-3) Additives

In addition to the resin material and the filler described above, the resin layer 17 can include various additives. The resin layer 17 can include, for example, a flame retardant and the like as additives.

(Flame Retardant)

The flame retardant is not particularly limited. As the flame retardant, either a halogen flame retardant or a non-halogen flame retardant may be used. The non-halogen flame retardant is preferably used especially from the viewpoint of decreasing the environmental load.

For example, the resin layer 17 can include, as the flame retardant, one or more selected from phosphorus flame retardants; nitrogen flame retardants; metal hydroxides and metal oxides such as magnesium hydroxide, aluminum hydroxide, and antimony trioxide.

(Other Additives)

The resin layer 17 can include, for example, an antioxidant, a deterioration inhibitor, a colorant, a cross-linking aid, a tackifier, a lubricant, a softener, a filler, a processing aid, a coupling agent, and the like, which are commonly formulated in resin layers.

Examples of the antioxidant include phenol-based antioxidants, amine-based antioxidants, sulfur-based antioxidants, phosphite ester-based antioxidants, and the like.

Examples of the deterioration inhibitor include hindered amine-based photostabilizers (HALS), ultraviolet absorbers, metal deactivators, hydrolysis inhibitors, and the like.

Examples of the colorant include carbon black, titanium white, other organic and inorganic pigments, and the like. Any of these can be added to the resin layer 17 for identification or for ultraviolet absorption.

In order to increase the crosslinking efficiency when cross-linking the resin material of the resin layer 17, the cross-linking aid may be added in an amount of 1 part by mass or more and 10 parts by mass or less relative to 100 parts by mass of the resin material included in the resin layer 17. Examples of the cross-linking aid include triallyl isocyanurate, triallyl cyanurate, trimethylolpropane trimethacrylate, N, N′-methaphenylene bismaleimide, ethylene glycol dimethacrylate, zinc acrylate, zinc methacrylate, and the like.

Examples of the tackifier include coumarone-indene resins, polyterpene resins, xylene formaldehyde resins, hydrogenated rosin, and the like. Examples of the lubricant include fatty acids, unsaturated fatty acids, their metal salts, fatty acid amides, fatty acid esters, and the like. Examples of the softener include mineral oils, vegetable oils, plasticizers, and the like. Examples of the filler include calcium carbonate, talc, clay, silica, zinc oxide, molybdenum oxide, and the like. As the coupling agent, a silane coupling agent, or a titanate-based coupling agent, such as isopropyl triisostearoyl titanate or isopropyl tri(N-aminoethyl-aminoethyl) titanate, may be added as necessary.

(3) Other Members

The cable according to the present embodiment can include any members in addition to the plurality of electrical wires and the resin layer. The members will be described below.

(3-1) Another Resin Layer

The cable 10 according to the present embodiment can include another resin layer 18 that covers the plurality of electrical wires 11, that is, covers the core 100.

The other resin layer 18 covering the core means that the core 100 is disposed within the other resin layer 18, and the other resin layer 18 and the core 100 do not necessarily contact each other. Therefore, for example, any member such as the above-described resin layer 17 may be disposed between the core 100 and the other resin layer 18. Note that the resin layer 17 and the other resin layer 18 are not necessarily required to be arranged as will be described later. The resin layer 17 may be referred to as a first resin layer, and the other resin layer 18 may be referred to as a second resin layer.

When the cable 10 according to the present embodiment includes the other resin layer 18, the plurality of electrical wires 11 can be protected, and the strength of the cable 10 can be thus enhanced.

The other resin layer 18 can include a resin material. As the resin material of the other resin layer 18, any of the materials described with respect to the resin material of the resin layer 17 can be suitably used, and thus, the description of the resin material of the other resin layer 18 will be omitted. The resin material of the other resin layer 18 may or may not be cross-linked. If the resin material is cross-linked, the heat resistance and the strength of the cable 10 can be enhanced. Therefore, if the cable 10 is used for applications requiring heat resistance, and strength, the resin material of the other resin layer 18 is preferably cross-linked.

The other resin layer 18 may include the same resin material as the resin layer 17.

When the other resin layer 18 includes the same resin material as the resin layer 17, the adhesion between the resin layer 17 and the other resin layer 18 can be improved, thus increasing durability.

The other resin layer 18 can include a filler. As the filler of the other resin layer 18, any of the materials described with respect to the filler of the resin layer 17 can be suitably used, and thus, the description of the filler of the other resin layer 18 will be omitted.

The other resin layer 18 can include additives in addition to the resin material. As the additives of the other resin layer 18, a flame retardant and any other additive described with respect to the additives of the resin layer 17 can be suitably used, and thus, the description of the additives of the other resin layer 18 will be omitted.

The arrangement of the resin layer 17 and the other resin layer 18 is not particularly limited. For example, as illustrated in FIG. 1, the resin layer 17 and the other resin layer 18 may be arranged in this order from a position closer to the core 100. The arrangement of the resin layer 17 and the other resin layer 18 may be reversed, and the other resin layer 18 and the resin layer 17 may be arranged in this order from a position closer to the core 100. For example, as illustrated in FIG. 1, the resin layer 17 and the other resin layer 18 may be arranged so as to contact each other.

(3-2) Separator

The cable 10 according to the present embodiment can include a separator 14 between the core 100 and the resin layer 17.

When the cable 10 according to the present embodiment includes the separator 14, the resin layer 17 can be readily removed when the plurality of electrical wires 11 is taken out, and the workability when performing wiring and the like can be improved. When the cable 10 includes the other resin layer 18, the separator 14 is preferably disposed at a position closer to the core 100 than the resin layer 17 and the other resin layer 18 are.

The configuration of the separator 14 is not particularly limited. For example, the cable 10 can include, as the separator 14, a lubricant 15 applied to the surfaces of the plurality of electrical wires 11. As the lubricant 15, a powder material can be used, and for example, talc or the like can be used.

Further, the cable 10 can include, as the separator 14, a wrapping tape 16 that covers the outer periphery of the core 100. The wrapping tape can be preferably formed by wrapping a tape body spirally around the outer periphery of the core 100 along the longitudinal direction of the core 100. The tape body is formed of an insulation material such as paper, a non-woven fabric, a resin such as polyester, or the like. As the wrapping tape 16, metal wires, fiber yarns, or the like can also be used. If metal wires or fiber yarns are used as the wrapping tape 16, the metal wires or the fiber yarns may be wrapped spirally around the core 100 along the longitudinal direction of the core 100, or may be braided so as to form a braided structure and disposed on the outer periphery of the core 100.

### EXAMPLES

Although specific examples will be described below, the present invention is not limited to these examples.

(Evaluation Method)

First, an evaluation method of cables produced in the following Experimental Examples will be described.

(1) Thicknesses of Resin Layer and Another Resin Layer

The thickness T17 of a resin layer 17 and the thickness T18 of another resin layer 18 were calculated from the outer diameter D100 of a core 100, the outer diameter D17 of the resin layer 17, and the outer diameter D10 of a cable 10.

The outer diameter D100 of the core 100 corresponds to the diameter of a circumscribed circle C1 of the core 100 in any cross section perpendicular to the longitudinal direction of the cable 10. In each of the following Experimental Examples, a lubricant 15, serving as a separator 14, was applied to the outer surfaces of a plurality of electrical wires 11. Therefore, the outer diameter of the core 100 is the diameter of the circumscribed circle C1 in which the separator 14 is included.

The outer diameters of the resin layer 17 were measured along two orthogonal diameters in the same cross section as in the case of the outer diameter D100 of the core 100 and the average value of the outer diameters was taken as the outer diameter D17 of the resin layer 17. The outer diameter D10 of the cable 10 was measured in the same manner as the outer diameter D17 of the resin layer 17, except that the target diameter is the outer diameter D10 of the cable 10.

The outer diameter D100 of the core 100 was subtracted from the outer diameter D17 of the resin layer 17, and the result was divided by 2 to obtain the thickness T17 of the resin layer 17.

The outer diameter D17 of the resin layer was subtracted from the outer diameter D10 of the cable 10, and the result was divided by 2 to obtain the thickness T18 of the other resin layer 18.

In each of Experimental Examples 1 to 3 below, a cable 30 having the same configuration as the cable 30 illustrated in FIG. 3 was produced. Instead of the outer diameter D100 of the core 100, the outer diameter D300 of a core 300, which corresponds to the diameter of a circumscribed circle C2, was used to calculate the thickness T17 of a resin layer 17. Further, instead of the outer diameter D10 of the cable 10, the outer diameter D30 of the cable 30 was used to calculate the thickness T18 of another resin layer 18. Except for the above points, the thicknesses of the resin layer 17 and the other resin layer 18 were obtained in the same manner as described above.

In Table 1, in the field of “thickness” of “resin layer”, “X” means a thickness of 0.35 millimeter (mm), “Y” means a thickness of 0.5 mm, and “Z” means a thickness of 0.6 mm.

Further, in the field of “thickness” of “another resin layer”, “A” means a thickness of 0.35 mm, “B” means a thickness of 0.5 mm, and “C” means a thickness of 0.5 mm.

(2) Bending Test

The evaluation was performed in accordance with an automobile standard JASO C467-97 7.16 sensor harness bending test specified by a public interest incorporated association, Society of Automotive Engineers of Japan, Inc. In the bending test, each of the cables was repeatedly bent from a linear shape to a U-shape. After each of the cables was bent 300,000 times at −30° C., each of the cables was bent 1,200,000 times at room temperature (25° C.). After the bending test, if no appearance abnormality such as breaking and cracking was observed and the rate of increase in resistance value of an electrical wire from the initial resistance value was less than 5%, the electrical wire was evaluated as “A”, that is, “pass”. Conversely, if an appearance abnormality such as breaking and cracking was observed, or the rate of increase in resistance value of an electrical wire from the initial resistance value was 5% or more, the electrical wire was evaluated as “B”, that is, “fail”.

In the following, the cables produced in Experimental Examples will be described.

Experimental Examples 1 to 5 are examples according to the present disclosure, whereas Experimental Example 6 is a comparative example.

### Experimental Example 1

In Experimental Example 1, in a cross section perpendicular to the longitudinal direction of the cable, a cable having the same configuration as the cable 30 illustrated in FIG. 3 and including two electrical wires 11 was produced and evaluated.

(1) Electrical Wires 11

(Conductor)

As a conductor, a stranded wire obtained by twisting conductor wires, which were copper alloy wires, was used. In the field of “electrical wire”, the conductor cross-sectional area of the conductor is indicated in the field of “conductor cross-sectional area”.

(Insulator)

Polyethylene (PE), serving as a resin material, was supplied into an extruder and molded to cover the outer surface of the resin material to form an insulator. In the field of “electrical wire” in Table 1, the resin material used to form the insulator of each of the electrical wires 11 is indicated in the field of “insulator”.

The two electrical wires 11 were twisted together to form a core 300. Then, talc, a lubricant 15, serving as a separator 14, was applied to the surface of the core 300. In table 1, the number of the electrical wires included in the cable is indicated in the field of “number of electrical wires”, and the material of the separator is indicated in the field of “separator”.

(2) Resin Layer

A compound obtained in advance by kneading polyurethane (PU), serving as a resin material, and starch, serving as a filler, was supplied into the extruder and molded to cover the outer surface of the core 300 to form a resin layer 17. In the field of “resin layer” in Table 1, the resin material used to form the resin layer 17 is indicated in the field of “resin material”, and the material used as the filler is indicated in the field of “filler”. Note that, in each of Experimental Examples, a chemical substance produced from a biological material was used as a filler as indicated in Table 1.

The resin material and the filler were kneaded such that the content of the filler in the resin layer 17 was the value as indicated in the field of “filler content” in Table 1.

(3) Another Resin Layer

Polyurethane (PU), serving as a resin material, was supplied into the extruder and molded to cover the outer surface of the resin layer 17 to form another resin layer 18. After the other resin layer was formed, the cable was irradiated with electron beams to cross-link the resin materials of the resin layer 17 and the other resin layer 18.

In the field of “another resin layer” in Table 1, the resin material used to form the other resin layer 18 is indicated in the field of “resin material”, and whether or not the resin material of the other resin layer 18 is cross-linked is indicated in the field of “cross-link”. The obtained cable was subjected to the bending test. The evaluation results were indicated in Table 1.

### Experimental Examples 2 and 3

The conductor cross-sectional areas of electrical wires 11, resin materials used to form resin layers 17, materials of fillers, and the thicknesses of the resin layers 17 and resin layers were changed as indicated in Table 1. In addition, in Experimental Example 3, soft copper wires were used as conductor wires. Cables were produced under the same conditions as Experimental Example 1 except for the above points, and were evaluated. The evaluation results are indicated in Table 1.

In Table 1, EVA is an ethylene-vinyl acetate copolymer.

### Experimental Examples 4 to 6

Similar to the cable 10 illustrated in FIG. 1, in each of Experimental Examples 4 to 6, two first electrical wires 12 and two second electrical wires were used as a plurality of electrical wires 11. The two first electrical wires 12 were twisted together to form a twisted-pair electrical wire 130. Then, the twisted-pair electrical wire 130 and the two first electrical wires 12 were twisted together to form a core 100. The configurations of the electrical wires and the configurations of a resin layer 17 and another resin layer 18 are as indicated in Table 1. Resin materials of the resin layer 17 and the other resin layer 18 were not cross-linked. As conductor wires of the first electrical wires 12, soft coppers were used. As conductor wires of the second electrical wires 13, copper alloy wires were used.

Cables were produced in the same procedure as in Experimental Example 1 and were evaluated.

The evaluation results are indicated in Table 1.

TABLE 1

| | | | | | | EXPERIMENTAL | | EXPERIMENTAL | | EXPERIMENTAL | |
|---|---|---|---|---|---|---|---|---|---|---|---|
| | | | | | | EXAMPLE 4 | | EXAMPLE 5 | | EXAMPLE 6 | |
| | | | | | | FIRST | SECOND | FIRST | SECOND | FIRST | SECOND |
| | | | EXPERIMENTAL | EXPERIMENTAL | EXPERIMENTAL | ELECTRICAL | ELECTRICAL | ELECTRICAL | ELECTRICAL | ELECTRICAL | ELECTRICAL |
| | | | EXAMPLE 1 | EXAMPLE 2 | EXAMPLE 3 | WIRE | WIRE | WIRE | WIRE | WIRE | WIRE |
| CABLE | ELECTRICAL | CONDUCTOR | 0.25 | 0.25 | 2.0 | 1.8 | 0.25 | 1.8 | 0.25 | 1.8 | 0.25 |
| | WIRE | CROSS- | | | | | | | | | |
| | | SECTIONAL | | | | | | | | | |
| | | AREA | | | | | | | | | |
| | | (mm²) | | | | | | | | | |
| | | INSULATOR | PE | PE | PE | PE | PE | PE | PE | PE | PE |
| | NUMBER OF | | 2 | 2 | 2 | 2 | 2 | 2 | 2 | 2 | 2 |
| | ELECTRICAL | | | | | | | | | | |
| | WIRES | | | | | | | | | | |
| | SEPARATOR | | TALC | TALC | TALC | TALC | | TALC | | TALC | |
| | RESIN | RESIN | PU | EVA | PU | PU | | PU | | PU | |
| | LAYER | MATERIAL | | | | | | | | | |
| | | FILLER | STARCH | CELLULOSE | CALCIUM | STARCH | | STARCH | | STARCH | |
| | | | | | CARBONATE | | | | | | |
| | | FILLER | 10 | 10 | 10 | 10 | | 40 | | 50 | |
| | | CONTENT | | | | | | | | | |
| | | (MASS %) | | | | | | | | | |
| | | THICKNESS | X | X | Y | Z | | Z | | Z | |
| | ANOTHER | RESIN | PU | PU | PU | PU | | PU | | PU | |
| | RESIN | MATERIAL | | | | | | | | | |

| | | | | | | | |
|---|---|---|---|---|---|---|---|
| LAYER | THICKNESS | A | A | B | C | C | C |

| | | | | | | |
|---|---|---|---|---|---|---|
| CROSS-LINK | YES | YES | YES | NO | NO | NO |

| EVALUATION | BENDING | A | A | A | A | A | B |
|---|---|---|---|---|---|---|---|
| RESULTS | TEST | | | | | | |

Although the embodiments have been described in detail above, the present invention is not limited to a specific embodiment, and various modifications and alterations can be made within the scope described in the claims.

What is claimed is:

1. A cable comprising:
a core including a plurality of electrical wires, the plurality of electrical wires being twisted together; and
a first resin layer configured to cover the core,
wherein the first resin layer includes a resin material and a filler,
a content of the filler in the first resin layer is 10% by mass or more and 40% by mass or less, and
the filler is a chemical substance produced from a biological material.

2. The cable according to claim 1, further comprising a second resin layer configured to cover the core.

3. The cable according to claim 2, wherein the second resin layer includes a resin material that is same as the resin material of the first resin layer.

4. The cable according to claim 1, wherein the filler includes starch.

5. The cable according to claim 1, wherein the filler includes calcium carbonate.

6. The cable according to claim 1, wherein the filler includes cellulose.

7. The cable according to claim 1, wherein the resin material is cross-linked.

8. The cable according to claim 1, further comprising a separator between the core and the resin material.
